(19) United States
(12) Patent Application Publication
(10) Pub. No.: US 2011/0296338 A1
(43) Pub. Date: Dec. 1, 2011

(54) System and Method for Cross-Domain Communications for Web Browsers

(76) Inventor: Richard Morgan Helms, Sunderland (CA)

(21) Appl. No.: 12/788,627

(22) Filed: May 27, 2010

(51) Int. Cl. G06F 15/16; G06F 3/048

(52) U.S. Cl. 715/781; 709/217

(57) ABSTRACT

A system and method for cross-domain communications for web browsers are provided. A local computer system operated by a user executes a web browser in communication with a first domain and a second domain. A first frame in the web browser is associated with the first domain, a second frame in the web browser is associated the first domain and receives a request from the first frame for communication with the second domain, and a third frame in the web browser is associated with the second domain. The second frame receives information from the first frame to be communicated to the second domain, the second frame is associated with the second domain, and the information is transmitted to the third frame for subsequent transmission to the second domain.

### BACKGROUND OF THE INVENTION

1. Field of the Invention

The present invention relates generally to the field of web browser technology. More specifically, the present invention relates to a system and method for cross-domain communications for web browsers.

2. Related Art

Today's web browsers offer users of the Internet significant flexibility in terms of how web-based content can be accessed and viewed. One example of such flexibility is the “frame” feature provided by most web browsers. Frames are sub-divisions of a web browser screen, such that each sub-division of the screen can separately receive and display content. Usually, Javascript is the programming language utilized by programmers for control of, and communications between, frames within web browsers.

For security reasons, Javascript places certain restrictions on frames. For example, Javascript only permits cross-frame communications where both frames are assigned to the same domain. Additionally, while Javascript permits a frame to instruct another frame initially assigned to the same domain to change its domain assignment, once the domain change occurs, the two frames cannot subsequently communicate with each other. As such, web browsers cannot natively communicate across multiple domains using frames.

These rules present significant programming difficulties for programmers who wish to design frame-based systems that must communicate across multiple domains. These difficulties are particularly present in the field of web-based electronic learning systems (e.g., electronic learning systems compliant with the Sharable Content Object Reference Model (SCORM) standard), wherein course content and/or other components are limited to installation on only a single domain.

One approach to solving the cross-domain communications difficulty of existing web browsers is to provide a plug-in software module for the web browser, such as Adobe Flash, which intercepts communications between two frames and allows for cross-domain communications between the frames. This approach, however, requires the plug-in to be downloaded and installed by the user (requiring time and effort on the part of the user), and does not work with web browsers that do not have the plug-in.

### SUMMARY OF THE INVENTION

The present invention relates to a system and method for cross-domain communications for web browsers. The system includes a local computer system operated by a user, the local computer system executing a web browser and in communication with a first remote computer system on a first domain and a second remote computer system on a second domain. A first frame in the web browser is electronically generated by the local computer system, displayed to the user, and associated with the first domain. A second frame in the web browser is electronically generated by the local computer system and associated with the first domain, and a third frame in the web browser is electronically generated by the local computer system and is associated with the second domain. The second frame receives information from the first frame to be communicated to the second remote computer system on the second domain, and the second frame is associated with the second domain. The information is transmitted from the second frame to the third frame, and the third frame transmits the information to the second computer system on the second domain. The system could operate with an electronic learning campus and a learning management system, thereby allowing cross-domain communications between the electronic learning campus and the learning management system

The method for cross-domain communications in web browsers includes the steps of electronically generating first, second, and third frames in a web browser executing on a local computer system, assigning the first and second frames to a first domain having a first remote computer system, assigning the third frame to a second domain having a second remote computer system, receiving and displaying content generated by the first computer system in the first frame, receiving at the second frame information to be communicated to the second computer system from the first frame, assigning the second frame to the second domain, transmitting the information from the second frame to the third frame; and transmitting the information from the third frame to the second computer system on the second domain.

The computer-readable storage medium includes computer-readable instructions stored thereon for cross-domain communications for web browsers. The instructions, when executed by a computer system, cause the computer system to perform the steps of electronically generating first, second, and third frames in a web browser executing on a local computer system, assigning the first and second frames to a first domain having a first remote computer system, assigning the third frame to a second domain having a second remote computer system, receiving and displaying content generated by the first computer system in the first frame, receiving at the second frame information to be communicated to the second computer system from the first frame, assigning the second frame to the second domain, transmitting the information from the second frame to the third frame, and transmitting the information from the third frame to the second computer system on the second domain.

### BRIEF DESCRIPTION OF THE DRAWINGS

The foregoing features of the invention will be apparent from the following Detailed Description of the Invention, taken in connection with the accompanying drawings, in which:

FIG. 1 is a diagram showing the system for cross-domain communications for web browsers;

FIG. 2 is a diagram showing, in detail, components of a sample computer system on which the system could be implemented;

FIGS. 3-4 are flowcharts showing processing steps for cross-domain communications for web browsers; and

FIGS. 5-14 are diagrams illustrating cross-domain communications using browser frames.

### DETAILED DESCRIPTION OF THE INVENTION

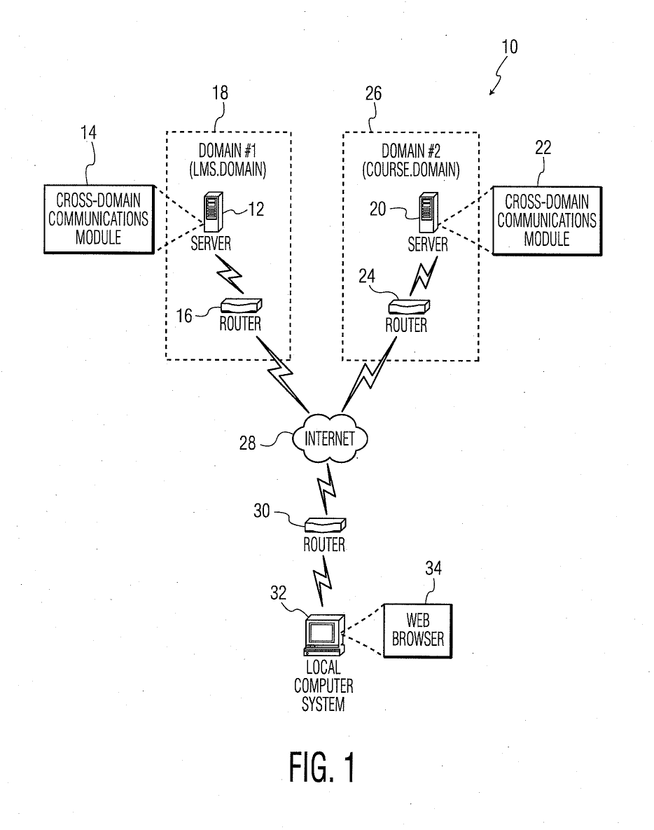

The present invention relates to a system and method for cross-domain communications for web browsers, as discussed in detail below in connection with FIGS. 1-14.

FIG. 1 is a diagram showing the system 10 for cross-domain communications for web browsers. A web browser 34 operating on a user's local computer system 32 can communicate with, and pass information between, a first computer system (e.g., server) 12 operating on a first Internet domain 18 (e.g., an Internet domain associated with a learning management system, such as the domain “LMS.domain”) and a second computer system 20 (e.g., server) operating on a second Internet domain 26 (e.g., an Internet domain associated with an e-learning course, such as the domain “COURSE.domain”). The computer systems 12, 20, and 32 are in communication with each other via the Internet 28 and various associated communications equipment, such as routers 16, 24, and 30. As will be discussed in greater detail below, the servers 12 and 20 execute cross-domain communications software modules 14 and 22, which permit the web browser 34 to communicate with and share information between the domains 18 and 26, without requiring installation of any third-party plug-in software on the local computing system 32.

The cross-domain communications modules 14 and 22 could be transmitted to the servers 12, 20 and executed thereby, or they could be pre-loaded onto, stored on, and/or executed by the servers 12, 20. The web browser 34 is preferably a Javascript-compatible web browser. The computer system 32 could be any suitable computer system having Internet connectivity and capable of executing a web browser, such as a personal (desktop) computer system, laptop computer, smart phone, personal digital assistant (PDA), tablet computer, or any other suitable type of computer system. Also, the computer system 32 could execute any suitable computer operating system, such as Windows, Linux, MacOS, Unix, etc.

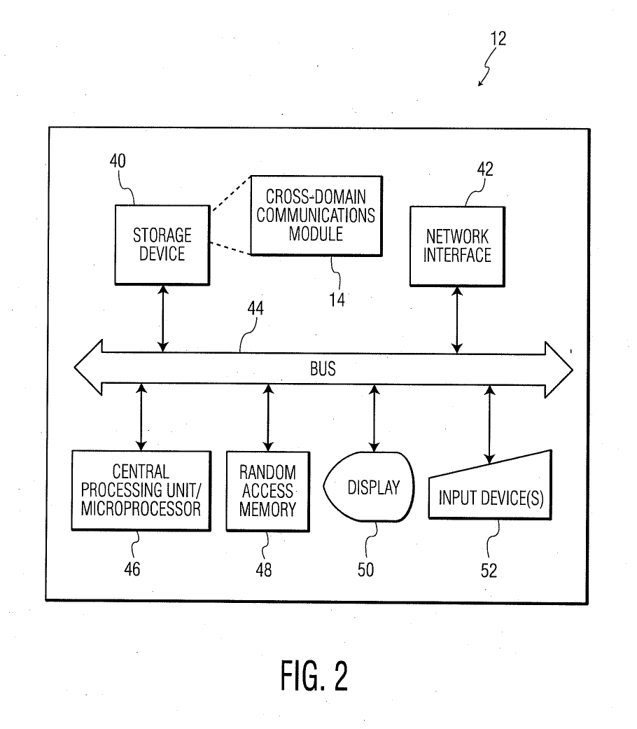

FIG. 2 is diagram showing hardware and software/firmware components of the server 12 of FIG. 1 in greater detail. It is noted that the server 20 of FIG. 1 could have components similar, or identical, to those shown in FIG. 2. The server 12 includes a non-volatile storage device 40 which stores the cross-domain communications module 14, a network interface 42, a bus 44, a central processing unit 46, a random access memory 48, a display 50, and one or more input devices 52. The storage device 40 could comprise any suitable, non-volatile, computer-readable storage medium capable of storing the cross-domain communications software module 32 of the present invention, such a disk and/or non-volatile memory (e.g., read-only memory (ROM), eraseable, programmable ROM (EPROM), electrically-eraseable, programmable ROM (EEPROM), flash memory, field-programmable gate array (FPGA), etc.). The network interface 42 could include any suitable type of network device for allowing the system 12 to communicate with the Internet, such as a wired or wireless Ethernet transceiver, etc. The central processing unit 46 could include any suitable single- or multiple-core microprocessor of any suitable architecture, such as an Intel microprocessor, AMD microprocessor, SPARC microprocessor, etc. The random access memory 48 could include any suitable, high-speed, random access memory typical of most modern computers, such as dynamic RAM (DRAM), etc. The display 50 could be any suitable computer display, such as a liquid crystal display (LCD), touchscreen, cathode ray tube (CRT), etc. The input device 52 could be any suitable user input device, such as a keyboard, mouse, touchpad, touchscreen, trackball, scroll wheel, etc.

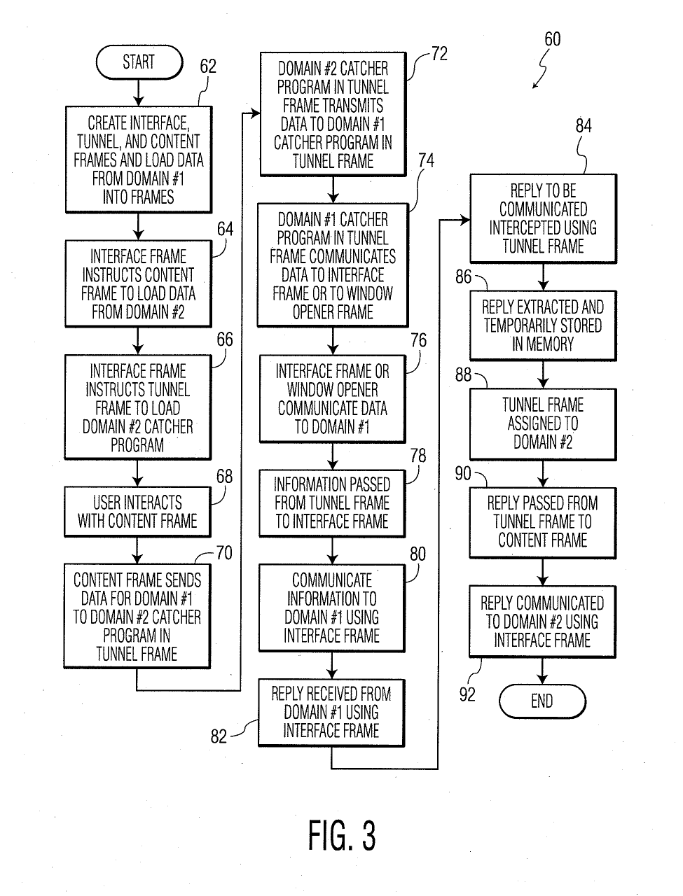

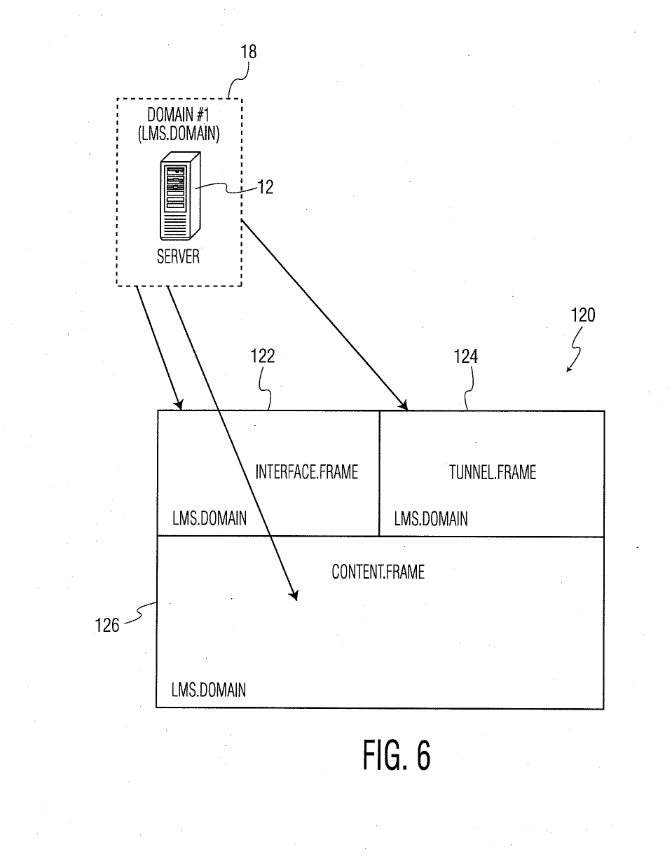

FIG. 3 is flowchart showing processing steps indicated generally at The processing steps 60 are carried out by the cross-domain communications software modules 14 and 22 of FIGS. 1-2. Beginning in step 62, when a web browser application is opened, the present invention creates three (3) frames in the web browser: an “interface” frame, a “tunnel” frame, and a “content” frame. As will be shown and discussed below in connection with FIGS. 6-14, the content frame is viewable by the user, but the interface and tunnel frames are not; that is, while the interface and tunnel frames exist in memory associated with the web browser, they are not displayed to the user. After the three frames have been created, data from the first domain 18 (Domain #1, e.g., the LMS domain discussed above in connection with FIG. 1) is loaded into the frames, whereupon all three frames are associated with the first domain 18. Then, in step 64, the interface frame instructs the content frame to load data from the second domain 26 (Domain #2, e.g. the Course domain discussed above in connection with FIG. 1), causing the interface frame to be assigned to the second domain 26. Then, in step 66, the interface frame instructs the tunnel frame to load a catcher program associated with Domain #2 (i.e., a catcher associated with the second domain 26), causing the interface frame to be associated with the second domain 26. In step 68, a user interacts with the content frame, e.g., by answering one or more questions forming part of an e-learning program and transmitted to the content frame by the second domain 26.

In step 70, the content frame sends data that ultimately is to be communicated to the first domain (i.e., domain 18 of FIG. 1), to the Domain #2 catcher program in the tunnel frame. Then, in step 72, the Domain #2 catcher program in the tunnel frame transmits the data to a catcher program in the tunnel frame that is associated with Domain #1 (i.e., associated with the first domain 18 of FIG. 1). To accomplish this, the Domain #2 catcher program calls the Domain #1 catcher program from the first domain 18, passing the data along with the call. This automatically changes the domain name association of the tunnel frame, i.e., the association of the tunnel frame changes from Domain #2 (i.e., the second domain 26 of FIG. 1) to Domain #1 (i.e., the first domain 18 of FIG. 1). Then, in step 74, the Domain #1 catcher program in the tunnel frame communicates the data to the interface frame, or, optionally, a window opener frame (i.e., the program that opened the current window). Also, prior to loading the Domain #1 catcher program, the tunnel frame could communicate with the second domain (i.e., the second domain 26 of FIG. 1) to transmit a student's answer(s) to one or more questions posed by an e-learning system, etc.

In step 76, the interface frame or the window opener frame communicate the data to Domain #1 (i.e., to the first domain 18 of FIG. 1). Then, in step 78, since the tunnel frame and the interface frame are associated with the same domain (Domain #1), information can be passed from the tunnel frame to the interface frame. Also, in step 80, the interface frame can communicate information to Domain #1, since it is associated with Domain #1. For example, the interface frame could communicate a student's overall score to Domain #1, verify that a student participated in a test forming part of an e-learning course served by Domain #2, etc.

In step 82, the interface frame receives a reply (to be communicated to the second domain) from the first Internet domain in response to the information transmitted to it by the interface frame. Then, in step 84, the tunnel frame receives the reply. In step 86, the present invention extracts the reply information, and temporarily stores it in memory. Then, in step 88, the tunnel frame is assigned back to the second Internet domain (Domain #2). In step 90, the reply information is retrieved from memory, and passed to the content frame for display to the user. Optionally, in step 92, the reply information could be communicated to the second domain by the tunnel frame. Since the tunnel frame has been assigned back to Domain #2, it can communicate with Domain #2 (e.g., using one or more Javascript function calls).

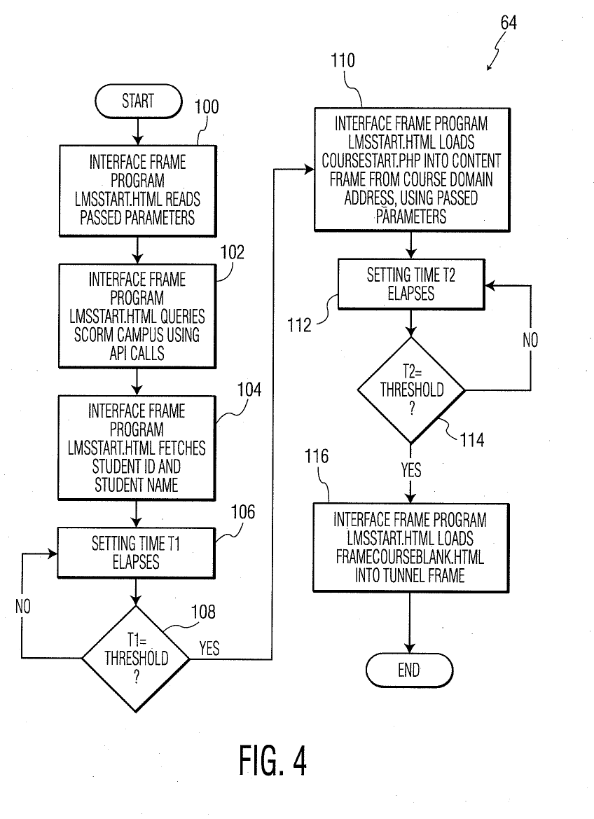

FIG. 4 is a flowchart showing step 64 of FIG. 3 in greater detail. For purposes of illustration, the processing steps shown in FIG. 4 are described in connection with two types of systems operating on two separate Internet domains: a learning management system, and an e-learning course system (“campus). In step 100, a program responsible for creating the interface frame (e.g., program “lmsstart.html”) reads parameters information passed to it, such as the name and Internet address of an e-learning course system. Then, in step 102, the interface frame program queries the second Internet domain (e.g., a SCORM campus) using Javascript application programmer interface (API) calls. In step 104, the interface frame program fetches login information to be passed to the second Internet domain, such as a student identifier (ID) and a student name. In step 106, a “settling” time T1 elapses, during which time information from both the first and second Internet domains is displayed in the interface and content windows. In step 108, a determination is made as to whether the settling time T1 has elapsed. If not, step 106 is repeated. Otherwise, step 110 occurs.

In step 110, the interface frame program loads a program for initiating the e-learning course system (e.g., program “coursestart.php”) into the content frame. This program can be supplied from the course domain address. The content frame passes the parameters obtained in step 104 (e.g., the student ID and name) to the e-learning course system (e.g., using URL “post” and/or “get” commands) Then, in step 112, a second “settling” time T2 elapses, so as to provide time for the e-learning course system to process the parameters passed to it by the content frame. In step 114, a determination is made as to whether the settling time T2 has elapsed. If not, step 112 is repeated. Otherwise, step 116 occurs, wherein the interface frame program sets up the tunnel frame (e.g., using a program “framecourseblank.html”) for communication with the e-learning course system. Processing then ends.

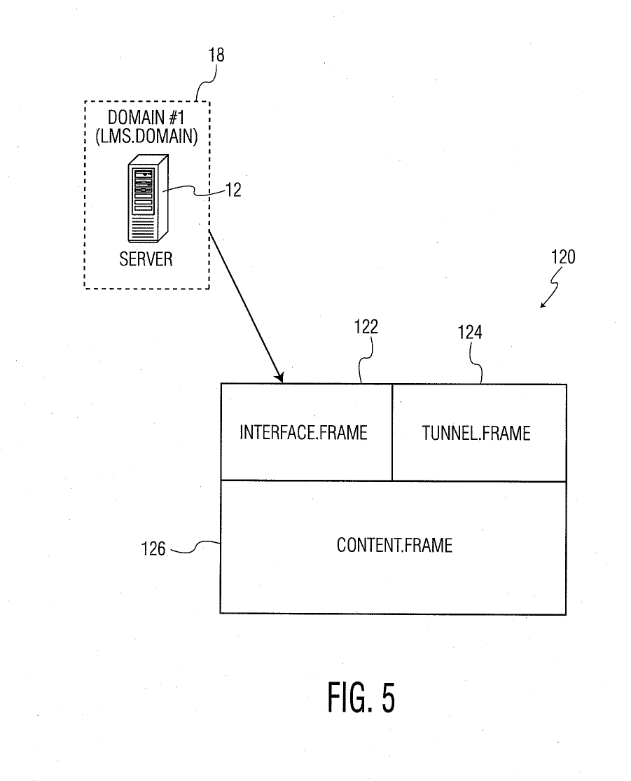

For purposes of illustration, the system for cross-domain communications is now shown with respect to FIGS. 5-14.

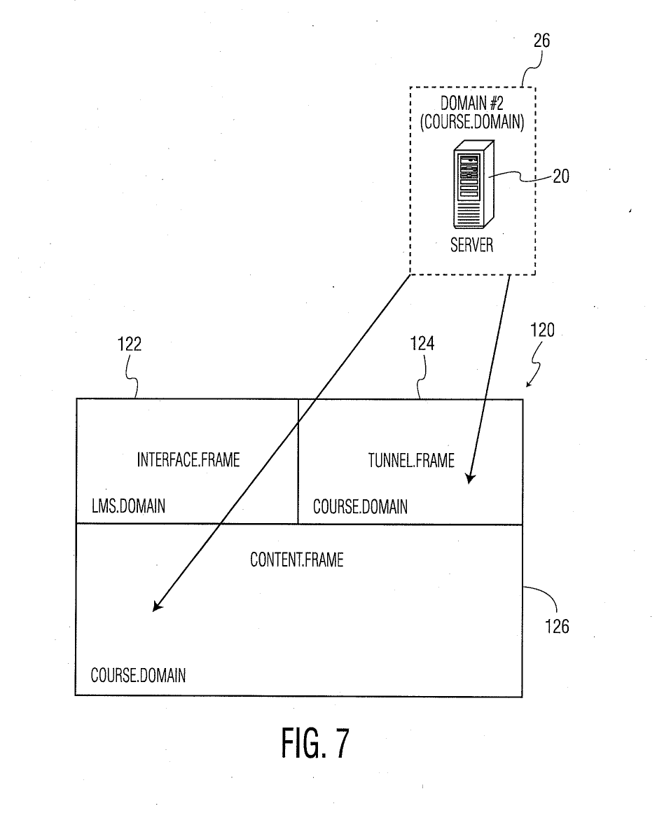

As shown in FIG. 5, when a web browser 120 is launched, it is instructed by the server 12 of the first Internet domain 18 to create three frames, i.e., the interface frame 122, the tunnel frame 124, and the content frame 126. Only the content frame 126 is viewable by the user; the interface frame 122 and tunnel frame 124 is hidden from view. Then, as shown in FIG. 6, the server 12 loads content into the frames 122-126, thereby automatically assigning the frames 122-126 to the first Internet domain 18, i.e., to the domain “LMS.domain.” The content could be loaded into the frames 122-126 using URL “post” and “get” commands. As shown in FIG. 7, the interface frame 122 instructs the tunnel frame 124 and the content frame 126 to load data from the second Internet domain 26 (e.g., using URL “post” and “get” commands), thereby automatically changing the domain association of the tunnel frame 124 and the content frame 126 to the second Internet domain, i.e., the domain “COURSE.domain.”

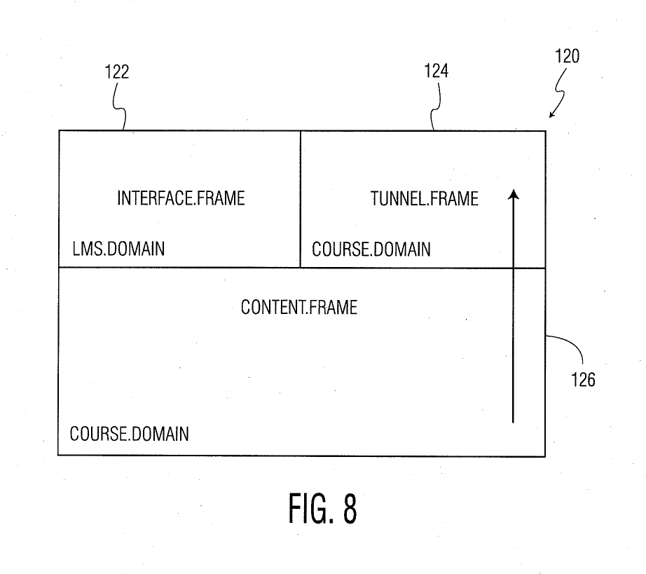

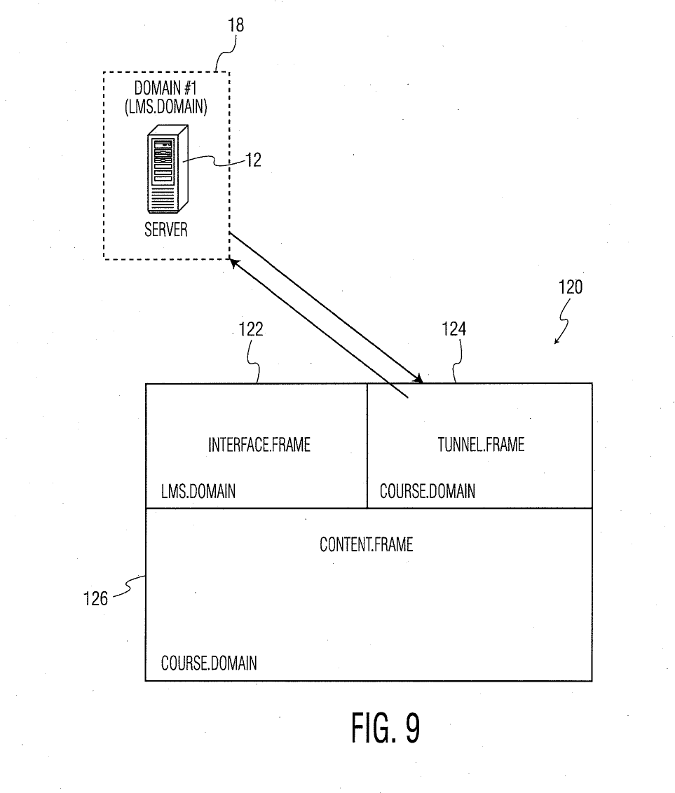

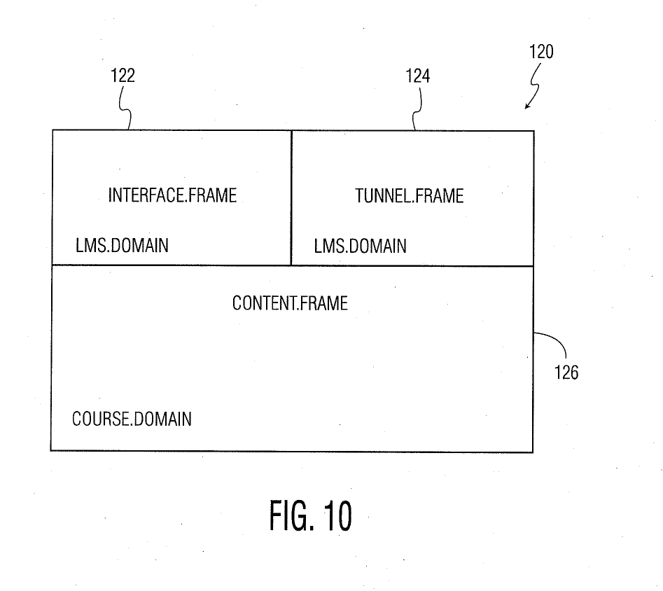

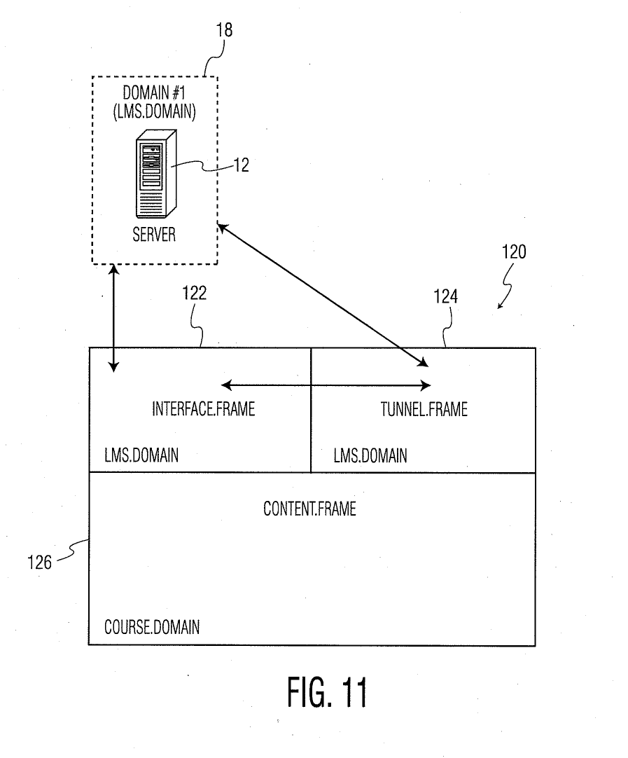

As can be seen in FIG. 8, the tunnel frame 124 receives a request to communicate with the first Internet domain generated by the content frame 122 (e.g., using one or more Javascript function calls, and/or URL “post” or “get” commands). Then, as illustrated in FIG. 9, the tunnel frame 124 communicates the data that it received from the content frame to the first Internet domain 12 (e.g., using URL “post” and/or “get” commands). As shown in FIG. 10, as a result of the transmission of the data to the first Internet domain 18, the tunnel frame 124 is assigned to the same domain assigned to the interface frame 122, i.e., to the first Internet domain “LMS.domain.” As can be seen in FIG. 11, the tunnel frame 124 can communicate with both the first Internet domain 18 and with the Interface frame 122, since it is on the same domain (“LMS.domain”) as the interface frame 122 and the first Internet domain 18. Also, the interface frame 122 can communicate with the first Internet domain 18, since it is on the same domain.

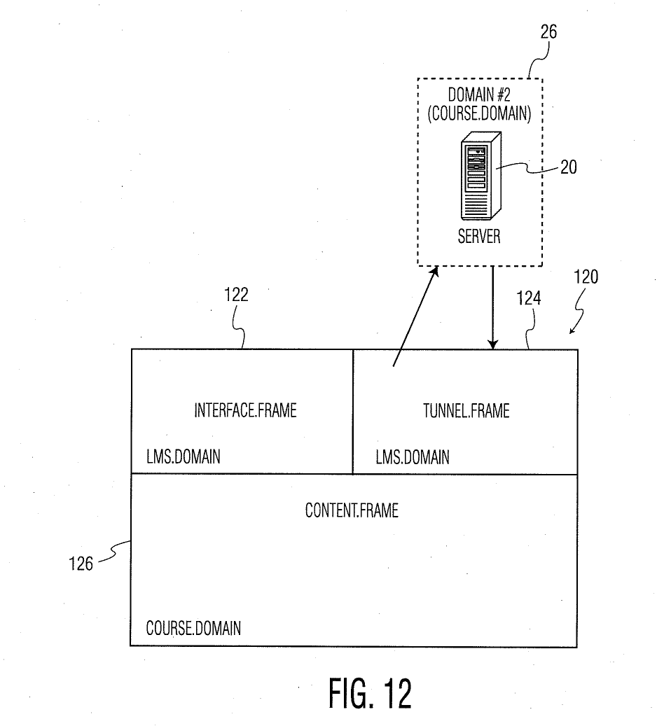

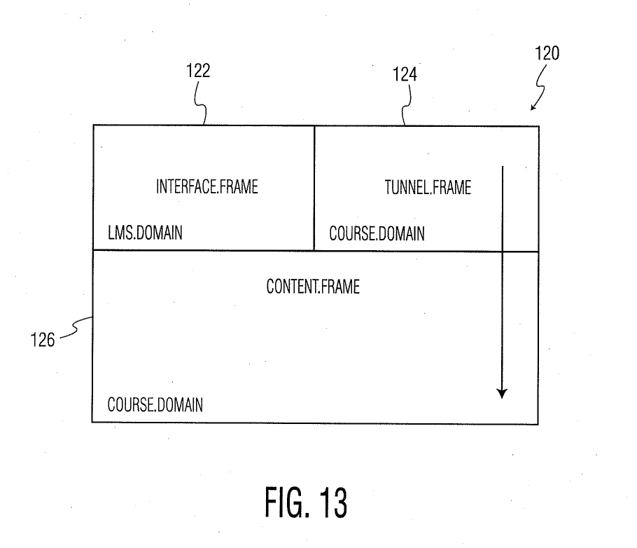

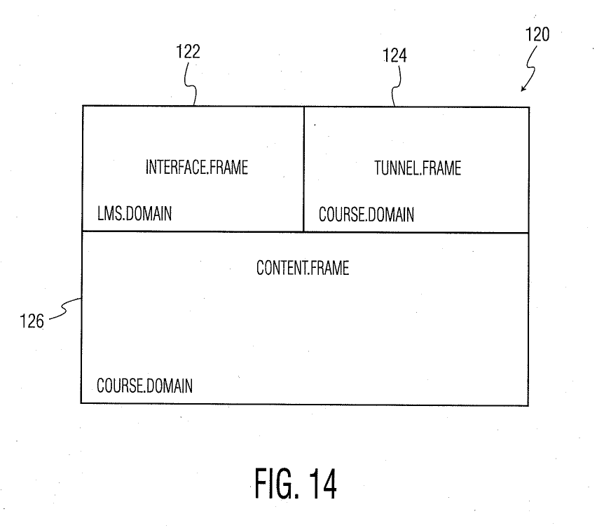

When a reply is received from the first Internet domain 18, the reply is received by the interface frame 122 and intercepted by the tunnel frame 124 (e.g., using one or more Javascript function calls). Then, as shown in FIG. 12, the tunnel frame 124 extracts the reply, temporarily stores the reply in memory, and is assigned to the same Internet domain as the content frame 126 (e.g., the domain COURSE.domain, using URL “post” and/or “get” commands). At this point, the tunnel frame 124 retrieves the reply from memory and transmits the reply to the content frame 126 (e.g., using one or more Javascript function calls) as shown in FIG. 13. Finally, as shown in FIG. 14, the content frame 126 displays the reply. The reply could also be transmitted by the content frame 126 to the COURSE.domain Internet domain.

Although the foregoing description is set forth in the context of cross-domain communications for web browsers across two Internet domains, it is noted that the present invention is not limited to the use of Internet domains. Indeed, the present invention could be applied to allow communications across two domains within a single network, such as two domains within a single corporate wide-area network, a campus network, etc.

The present invention could be coded in any suitable high- or low-level language, such as hypertext markup language (HTML) and/or Extensible Markup Language (XML). An example of XML code for configuring the cross-domain communications system of the present invention for use in connection with a learning management system and an electronic campus (each on different Internet domains) is provided in Table 1, below.

<?xml version=“1.0” encoding=“utf-8” ?>
<manifest identifier=“ims_hello” version=“1.0”

xmlns=“http://www.imsproject.org/xsd/imscp_rootv1p1p2”
xmlns:adlcp=“http://www.adlnet.org/xsd/adlcp_rootv1p2”
xmlns:xsi=“http://www.w3.org/2001/XMLSchema-instance”>

<metadata>

<schema>ADL SCORM</schema>
<schemaversion>CAM 1.3</schemaversion>

</metadata>
<organizations default=“crs_hello”>

<organization identifier=“crs_hello”>

<title>Cross Domain Course</title>

<item identifier=“sco_hello”

identifierref=“sco_hello_ref”>

<title>Cross Domain Lesson</title>

</item>

</organization>

</organizations>
<resources>

<resource identifier=“sco_hello_ref”

type=“webcontent”
href=“lmsframe.html?course=lpq&addr=lpcertification.ca/LossPreventionTest/”
adlcp:scormtype=“sco”>

</resource>

</resources>

</manifest>

Having thus described the invention in detail, it is to be understood that the foregoing description is not intended to limit the spirit or scope thereof. What is desired to be protected is set forth in the following claims.

What is claimed is:

1. A system for cross-domain communications for web browsers, comprising:
a local computer system operated by a user, the local computer system executing a web browser and in communication with a first remote computer system on a first domain and a second remote computer system on a second domain;
a first frame in the web browser electronically generated by the local computer system and displayed to the user, the first frame associated with the first domain;
a second frame in the web browser electronically generated by the local computer system, the second frame associated with the first domain; and
a third frame in the web browser electronically generated by the local computer system, the third frame associated with the second domain,
wherein the second frame receives information from the first frame to be communicated to the second remote, computer system on the second domain, the second frame is associated with to the second domain, the information is transmitted from the second frame to the third frame, and the third frame transmit the information to the second computer system on the second domain.

2. The system of claim 1, wherein the first frame displays content transmitted to the web browser from the first computer system on the first domain.

3. The system of claim 1, wherein the third frame receives a reply from the second computer system in response to the information transmitted to the second computer system by the third frame.

4. The system of claim 3, wherein the third frame transmits the reply to the second frame.

5. The system of claim 4, wherein the second frame is associated with the first domain.

6. The system of claim 5, wherein the second frame transmits the reply to the first frame and the first frame displays the reply to the user.

7. The system of claim 5, wherein the second frame transmits the reply to the first computer system on the first domain.

8. The system of claim 1, wherein the first domain is associated with an electronic learning campus and the first remote computer system forms at least part of the electronic learning campus.

9. The system of claim 8, wherein the second domain is associated with a learning management system and the second remote computer system forms at least part of the learning management system.

10. A method for cross-domain communications in web browsers, comprising the steps of:
electronically generating first, second, and third frames in a web browser executing on a local computer system;
associating the first and second frames with a first domain having a first remote computer system;
associating the third frame to a second domain having a second remote computer system;
receiving and displaying content generated by the first computer system in the first frame;
receiving at the second frame information to be communicated to the second computer system from the first frame;
associating the second frame to the second domain;
transmitting the information from the second frame to the third frame; and
transmitting the information from the third frame to the second computer system on the second domain.

11. The method of claim 10, further comprising displaying in the first frame content transmitted to the web browser from the first computer system on the first domain.

12. The method of claim 10, further comprising receiving using the third frame a reply from the second computer system in response to the information transmitted to the second computer system by the third frame.

13. The method of claim 12, further comprising transmitting the reply from the third frame to the second frame.

14. The method of claim 13, further comprising associating the second frame to the first domain.

15. The method of claim 14, further comprising transmitting the reply from the second frame to the first frame for subsequent displaying of the reply to the user in the first frame.

16. The method of claim 14, further comprising transmitting the reply from the second frame to the first computer system on the first domain.

17. A computer-readable storage medium having computer-readable instructions stored thereon for cross-domain communications for web browsers, wherein when the instructions are executed by a computer system, the instructions cause the computer system to perform the steps comprising:
electronically generating first, second, and third frames in a web browser executing on a local computer system;
associating the first and second frames to a first domain having a first remote computer system;
associating the third frame to a second domain having a second remote computer system;
receiving and displaying content generated by the first computer system in the first frame;
receiving at the second frame information to be communicated to the second computer system from the first frame;
associating the second frame to the second domain;
transmitting the information from the second frame to the third frame; and
transmitting the information from the third frame to the second computer system on the second domain.

18. The computer-readable storage medium of claim 17, further comprising displaying in the first frame content transmitted to the web browser from the first computer system on the first domain.

19. The computer-readable storage medium of claim 17, further comprising receiving using the third frame a reply from the second computer system in response to the information transmitted to the second computer system by the third frame.

20. The computer-readable storage medium of claim 19, further comprising transmitting the reply from the third frame to the second frame.

21. The computer-readable storage medium of claim 20, further comprising associating the second frame to the first domain.

22. The computer-readable storage medium of claim 21, further comprising transmitting the reply from the second frame to the first frame for subsequent displaying of the reply to the user in the first frame.

23. The computer-readable storage medium of claim 21, further comprising transmitting the reply from the second frame to the first computer system on the first domain.
